(19) United States
(12) Patent Application Publication
(10) Pub. No.: US 2022/0170862 A1
(43) Pub. Date: Jun. 2, 2022

(54) METHOD FOR DETERMINING A COLOR VALUE OF A TRANSPARENT BULK MATERIAL

(71) Applicant: Covestro Intellectual Property GmbH Co. KG, Leverkusen (DE)

(72) Inventors: Rafael Oser, Krefeld (DE); Joerg Reichenauer, Krefeld (DE); Hans-Bernhard Hauertmann, Dormagen (DE)

(21) Appl. No.: 17/437,186

(22) PCT Filed: Mar. 20, 2020
(86) PCT No.: PCT/EP2020/057713

§ 371 Date: Sep. 8, 2021

(30) Foreign Application Priority Data
Mar. 26, 2019 (EP) 19165157.9

(51) Int. Cl. G01N 21/85; G01N 21/27

(52) U.S. Cl. CPC G01N 21/85; G01N 2021/1785; G01N 21/27

(57) ABSTRACT

The invention relates to a method for determining an averaged color value of a transparent bulk material, which allows an online measurement of the averaged color value in transmission. Also disclosed is a sample of a transparent bulk material having an averaged color value with small standard deviation and a molded body which comprises such a sample.

### CROSS REFERENCE TO RELATED APPLICATIONS

This application is a U.S. national stage application, filed under 35 U.S.C. § 371, of International Application No. PCT/EP2020/057713, which was filed on Mar. 20, 2020, which claims priority to European Patent Application No. 19165157.9, which was filed on Mar. 26, 2019. The contents of each are hereby incorporated by reference into this specification.

### FIELD

The present invention relates to a method for determining an averaged color value of a transparent bulk material, to a sample of a transparent bulk material having an averaged color value having a low standard deviation and to a shaped article comprising such a sample.

### BACKGROUND

Determination of a color value of a transparent bulk material is often performed for quality reasons. For example waste glass from waste glass containers is first crushed in a roller crusher to a grain size of 10-50 mm and these individual shards are examined for their color. CCD cameras are used to record the images of the shards trickling through. On the individual images each individual shard of glass is analyzed and, depending on the detected color, then separated from the main flow by means of a compressed air flow. This results in resolution of the main flow according to the colors of each individual shard. This is important because when the glass is melted, even small concentrations of foreign colors can affect the overall color of the melted glass. A method for separating different types of glass by measuring individual particles in transmission is described for example in DE202004019684 U1.

Transparent polymer granulates too are examined for color after production for quality reasons. One aspect here is the bluish coloration of the granules which is measured by means of transmission. A CCD camera would not be suitable for such colorings. Furthermore, in contrast to the separation of waste glass, polymer granulates are subjected to measurement of an averaged color value since the bluish color deviation of a single granulate particle may not cause such great deviations over the overall larger volume element considered. This color determination is usually carried out using a spectral method: a sample of a granulate volume is taken, a transparent plate of a defined thickness is produced by melting and re-cooling the granulate volume, preferably by injection molding, and this solidified plate is analyzed by recording a transmission spectrum. This method has the disadvantage that due to its relative complexity such an analysis is carried out only every few hours during ongoing production. Consequently, any deviation in the color value determined during analysis may generate a very large amount of scrap since an intervention in the production process to change corresponding parameters in production to reoobtain the desired averaged color target value is undertaken only after some hours.

US2004/239926 A1 for example describes a method for online analysis of polymer granulate, wherein a multiplicity of granulates are held back and decelerated. The thus obtained measured volume is then measured in reflection and set in motion again. Although this is an online method a fixed deceleration of the granulate flow is nevertheless effected, thus leading to slight delays in the receipt of the determined color information.

WO2009/040291 A1 likewise describes the analysis of a granulate flow in reflection. The spectrometer utilized therefor allows measurement approximately every 2 to 10 s.

### SUMMARY

Starting from the specified prior art it was accordingly an object of the present invention to overcome at least one disadvantage of the prior art. It was a particular object of the present invention to provide an online color analysis including for cases in which an averaged color value of a transparent bulk material is to be determined. This shall make it possible to react to color deviations more quickly since these can be detected more quickly during ongoing production.

These objects were achieved by the method for determining an averaged color value according to the invention, by the sample according to the invention, by the shaped article according to the invention and by the use according to the invention.

A transparent bulk material, for example a granulate, usually comprises a large number of discrete solid particles which can all have a different shape. For example a granulate typically has a cylindrical and/or lenticular shape with substantially straight breaking edges. Even just this irregular shape means that the method of determining a color value by transmission differs from image recording using a CCD camera in reflection. When forming an average value over the color values of a volume element comprising a multiplicity of individual granulate particles (discrete solid particles), according to the orientation of an individual granulate particle in space analysis by transmission results in different values for the scattered light for each of these individual granulate particles. The scattered light results from reflection, total internal reflection and the presence or absence, position and size of vacuoles or cut edges, etc. There is overall a very high level of scattered light in such inhomogeneous bulk goods. The actual color information, which is the target of the analysis, can therefore be concealed by this scattered light. It was therefore very surprising that direct analysis of a granulate by transmission leads to usable results with regard to the obtained color value. According to the invention it has been found that in particular the air spaces, i.e. parts of the volume element to be analyzed in which no discrete solid particles are present, have an influence on the measured values.

Accordingly provided according to the invention is a method for determining an averaged color value of a sample of a transparent bulk material, wherein the sample comprises a multiplicity of transparent, discrete solid particles, wherein the determination is carried out continuously over different volume elements of the sample, wherein the volume element of the sample to be analyzed is in motion at least immediately before and after the analysis so that the bulk density of any volume element to be analyzed may vary, wherein for each analyzed volume element a color value is obtained and this color value is subsequently averaged over a number of the analyzed volume elements to obtain the averaged color value, characterized in that the color value of any volume element to be analyzed is obtained in transmission by recording a transmission spectrum in a wavelength range of 360-780 nm or by direct determination of the tristimulus values XYZ and only color values of an analyzed volume element for which a CIELab coordinate L* of not more than 95 was obtained from the measured data are taken into account for calculating the averaged color value.

### BRIEF DESCRIPTION OF FIGURES

A preferred embodiment of the apparatus according to the invention is shown in FIG. 1 The reference numerals have the following meanings:

1 transparent sample to be analyzed

2 Filter element

3 Scattered light

4 Light source

5 Receiver

6 Glass plates

7 Control of the flow of the transparent sample through adjustability of the slot

8 Continuous, constant flow of the transparent sample

9 Spectrophotometer or XYZ detector

10 Arithmetic unit

As elucidated hereinabove the apparatus according to the invention has the result that online measurement of the color value is made possible, thus allowing more flexible, faster, more effective and more economical running of production processes.

FIG. 2 shows the CIELab coordinate L* versus the number of analyzed volume elements for a polycarbonate sample. No inventive cleanup of the data via a maximum L* value was performed.

FIG. 3 shows a box plot of the CIELab coordinates a* and b* prepared from the data in FIG. 2.

FIG. 4 shows the CIELab coordinate L* versus the number of analyzed volume elements for the same polycarbonate sample as in FIG. 2. An inventive cleanup of the data via a maximum L* value of 95 was performed.

FIG. 5 shows a box plot of the CIELab coordinates a* and b* prepared from the data in FIG. 4.

FIG. 6 shows the CIELab coordinate L* versus the number of analyzed volume elements for the same polycarbonate sample as in FIG. 2. An inventive cleanup of the data via a maximum

L* value of 90 was performed.

FIG. 7 shows a box plot of the CIELab coordinates a* and b* prepared from the data in FIG. 6.

### DETAILED DESCRIPTION

It was also surprisingly found that the data obtained using the method according to the invention are only reliable when values for which a CIELab coordinate L* was calculated from the measured data are taken into account only when said coordinate is not more than 95, preferably not more than 90, particularly preferably not more than 85 and very particularly preferably not more than 80. Only by cleaning up the data by this maximum L* value are reliable averaged color values obtained. Otherwise, values with excessively high L* values are also included in the average value of the averaged color value with the result that the resulting average value is not very informative. This cleanup of the values according to the invention has the result that substantially all values formed from analysis of an air space are not taken into account. This means that such values are essentially values containing no color information for the discrete solid particles and thus exclusively conceal the desired information.

According to the invention it is also preferable when only color values of an analyzed volume element for which a CIELab coordinate L* of not less than 5, particularly preferably not less than 10, very particularly preferably not less than 20, was obtained from the measured data are taken into account for calculating the averaged color value. This accordingly makes it possible to filter out values resulting from obstruction of the discrete solid particles from the calculation of the average value. Such obstruction may arise from overlap of two discrete solid particles for example.

It was also found according to the invention that the obtained averaged color values are hardly temperature dependent. Usually the color of a sample depends on the temperature of the sample (thermochromism). If, for example, it is a polymer granulate which is granulated in an extruder, the granulate as a consequence of manufacture exhibits a temperature gradient immediately after this extruder (warmer on the inside than the outside). Depending on the type of extruder the individual granulate particles may therefore have different temperature since, for example, the surface of the granulate particles may have more water on it which evaporates and removes heat from the granulate particles. If the granulate is always analyzed at the same point downstream of an extruder, but a different extruder is used, this may mean that the target color values have to be adjusted since the granulate then has different temperatures at this point. However, it has surprisingly been found that the thermochromic effect in the method according to the invention is negligibly small. The method according to the invention is therefore very flexible since the target color values are independent of the temperature of the granulate. This results in particular in increased flexibility with regard to the type of cooling of the granulate immediately before measurement. In addition, the same color values are also obtained when the transparent bulk material is subsequently analyzed when it has a homogeneous temperature and no temperature gradient. Without wishing to be bound to a particular theory it is thought that the determination of an average value of different color values also partially averages out the thermochromic effect.

The method according to the invention altogether makes it possible to realize online measurement during production, thus allowing quicker and more efficient determination of color values. In particular, response times with regard to necessary adjustments to the process parameters in production are significantly reduced, thus resulting in a more stable production process and less scrap material. This altogether saves working time and energy. The method according to the invention may in principle also be performed at-line and this likewise results in the abovementioned advantages.

According to the invention a sample of a transparent bulk material is analyzed. In the context of the invention, the term “transparent” is preferably to be understood as meaning a material having an achromatic AE of not more than 10, preferably not more than 5. AE is known to the person skilled in the art and is defined for example according to DIN EN ISO 11664-4 (2011). The term “achromatic” is defined as L*>zero and a* and b*=zero. Transparent is likewise preferably to be understood as meaning that the sample has a transmission Y>50%, preferably >65%, very particularly preferably >85%, measured on a sample having a 4 mm layer thickness based on a D65 illuminant and a 10° observer according to DIN EN ISO 11664-4 (2011). Transmission Y is defined in DIN EN ISO 11664-1 (2011). In the context of the present invention the term “transparent” is particularly preferably to be understood as meaning that the sample has an achromatic AE of not more than 10, preferably not more than 5, and a transmission Y>50%, preferably >65%, very particularly preferably >85%, measured on a sample having a 4 mm layer thickness based on a D65 illuminant and a 10° observer according to DIN EN ISO 11664-4 (2011).

The transparent bulk material comprises a multiplicity of transparent, discrete solid particles. In the context of the present invention a “discrete solid particle” is preferably to be understood as meaning a particle which may differ in shape and optionally color from the other particles of the overall multiplicity of particles in the sample. These are preferably particles having at least one value of length, height or width of at least 0.5 to 5 mm. It is moreover preferable when the discrete solid particles of the sample do not have a uniform shape. For example, one parameter of the height, width and length of the discrete solid particle may be nonidentical to the respective other two parameters of height, width and length. Thus, for example, a spherical shape and a cubic shape are preferably excluded. The discrete solid particles very particularly preferably have a cylindrical and/or lenticular shape. However, slight deviations from these geometric shapes should also be encompassed by the term “discrete solid particles”. This cylindrical and/or lenticular shape is preferably characterized in that the discrete solid particles have a length of 0.5 to 5 mm, a width of 0.5 to 5 mm and a thickness of 0.5 to 5 mm. The discrete solid particles are very particularly preferably produced by means of a granulator. The discrete solid particles of the transparent sample are therefore a granulate. This granulate is moreover preferably obtained by an extrusion process.

It is likewise preferable when the sample of a transparent bulk material to be analyzed according to the invention comprises a transparent polymer. It may preferably also consist of a transparent polymer, wherein the polymer may still contain traces of the residual substances generated during production. The transparent polymer is moreover preferably selected from the group consisting of polycarbonate, polymethacrylate, polystyrene and styrene-acrylonitrile copolymers; the transparent sample is very particularly preferably a polycarbonate. Poly carbonates in the context of the present invention include not only homopolycarbonates but also copolycarbonates and/or polyestercarbonates; the polycarbonates may be linear or branched in a known manner Also employable according to the invention are mixtures of polycarbonates.

According to the invention various volume elements of the sample of the transparent bulk material are continuously analyzed. The individual volume elements preferably comprise more than one transparent, discrete solid particle. The respective volume element of the sample to be analyzed is in motion at least immediately before and after analysis. The volume element of the sample may be briefly decelerated for analysis. However, it is preferable when the volume element of the sample is also in motion at the time of measurement. The speed at which the volume element moves is slower than the speed of analysis. Analysis of the individual volume elements is preferably carried out while these are brought from a height hl to a height h2, wherein h1>h2. The volume element of the bulk material to be analyzed in each case trickles down. The flow rate of a volume element to be analyzed is preferably 0.5 to 10 kg per min, particularly preferably 0.75 to 5 kg per min and very particularly preferably 1 to 4 kg per min. The flow rate may be adjusted using methods known to those skilled in the art. This can preferably be set to the desired value by means of an aperture and by utilizing gravity or by means of an aperture and a conveying device.

Each of the volume elements to be analyzed may have a different bulk density. Although it cannot be ruled out here that two different volume elements have the same bulk density, the probability of this is very low, especially when, as elucidated above, the discrete solid particles preferably do not have a uniform shape. According to the invention the term “bulk density” is preferably to be understood as meaning the state of the discrete solid particles in a volume element. The state here includes at least the parameter of the number of discrete solid particles per volume. In addition, this state can also encompass the orientation of the discrete solid particles when the discrete solid particles do not have a uniform shape.

According to the invention a color value is obtained for each analyzed volume element. However, according to the invention not all color values are taken into account for determining the averaged color value, only those for which a CIELab coordinate L* of not more than 95 was obtained from the measured data. According to the invention the term “color value” preferably encompasses values which can be calculated from the color values XYZ. The term “color value” particularly preferably encompasses the transmission Y in %, the L*a*b* values and/or the yellowness index (YI) (preferably according to ASTM E 313-10 (observer: 10°/light type: D65) on sample plates with a film thickness of 4 mm). This color value is then averaged over a number of the analyzed volume elements to obtain the averaged color value. The color value of each volume element to be analyzed is obtained by recording a transmission spectrum in a wavelength range of 360-780 nm or by directly determining the color values XYZ in transmission. When a transmission spectrum is recorded in the wavelength range of 360-780 nm, alternatively of 400 to 700 nm, the Lab values according to CIELab are calculated therefrom. This color space and the corresponding calculation are known to those skilled in the art. L represents brightness, a the shift on the red-green axis and b the shift on the blue-yellow axis. The Lab values are calculated according to DIN EN ISO 11664-4 (2011).

Alternatively, the XYZ color values are directly obtained by analysis in transmission. These values are known as XYZ color values or else tristimulus values. These three values each specify a color in a color space in a manner known to those skilled in the art. The a* and b* values and the transmission Y or the L* value calculated from the transmission Y are calculated from the XYZ values. Here too, it is preferable when the CIELab values are calculated according to DIN EN ISO 11664-4 (2011). In particular it is preferable when a spectrophotometer and/or an XYZ detector is used for the analysis. The XYZ detector has the advantage that it can perform measurements particularly quickly since it only records three values. As a result, the speed of motion of the volume element to be analyzed at least immediately before and after analysis can also be high. This has the result that the production process for example may be run quickly and thus efficiently.

A volume element is preferably analyzed at least every 0.1 ms to at most every 2 s, particularly preferably every 0.5 ms to every 1.5, more preferably every 1 ms to at most every 1 s and very particularly preferably every 10 ms to at most every 1 s. It is likewise preferable when 2000 to 7000, preferably 3000 to 6000 and very particularly preferably 4500 to 5500 volume elements are analyzed and the averaged color value is obtained by averaging this number of for example 2000 to 7000, preferably 3000 to 6000 and very particularly preferably 4500 to 5500 analyzed volume elements with the proviso that these analyzed volume elements have a CIELab coordinate L* of not more than 95. This is accordingly to be understood as meaning that not all analyzed volume elements may be included overall in the averaging for calculating the averaged color value. However, according to the invention preferably at least 4500, particularly preferably at least 3000, very particularly preferably at least 2000 and especially preferably at least 1000 analyzed volume elements having a CIELab coordinate L* of not more than 95 should contribute to the average value of the averaged color value.

This high number of measurement points makes it possible to ensure a high precision for the method according to the invention. It is moreover preferable when analysis of the 2000 to 7000, preferably 3000 to 6000 and very particularly preferably 4500 to 5500 volume elements comprises analyzing 100 g to 10 kg, preferably 250 g to 8 kg and very particularly preferably 500 g to 7 kg of the sample. It has been found that the combination of a large number of measurements and a high measurement rate is comparable to a quasi-steady state. This has the advantage that the method according to the invention simplifies the description of state of the moving transparent sample. In particular, the obtained precision of the method according to the invention is higher than prior art methods in which samples are measured in reflection.

However, this high number of measurements at a high measurement rate can also result in a very large number of generated data points. Processing thereof can be resource intensive. It has been found according to the invention that it is further advantageous when, in the method according to the invention, prior to the determination of the averaged color value, a randomizing of the individual color values for each volume element is performed by averaging the individual color values obtained for each volume element. Only then is the averaged color value formed for each volume element using these randomized color values. The term “randomization” is known to those skilled in the art. In the randomization it is preferable when only specific measured color values are selected via a random mechanism and then included in the averaging of the averaged color value. Typically, a subgroup of a population is selected by a method which gives all samples equal probability. This can altogether significantly reduce the number of data points that are actually to be processed. However, the original information in the data is retained. The randomization is preferably carried out using a random number generator. The randomization can very particularly preferably be carried out using the software MiniTab version 17.

According to the invention it is preferable when the randomization of the individual color values for each volume element is performed such that at least 4500 data points, particularly preferably at least 2000 data points and very particularly preferably at least 1000 data points are included in the calculation of the averaged color value. It has been found to be advantageous when the randomization makes it possible to minimize disruptive influences from the test procedure.

The method according to the invention is particularly preferably used for quality control of the transparent sample. It is moreover preferred when the quality control is carried out during production of the transparent sample. It is apparent to those skilled in the art at which point in the production process it would be advantageous to perform the quality control. If for example the production process involves production of polycarbonate, the quality control is preferably carried out temporally downstream of the granulator, very particularly preferably immediately downstream of the granulator. Quality control is significantly improved on account of the high reproducibility of the method according to the invention.

The method according to the invention is preferably characterized in that the method comprises the following steps:
(a) determining the averaged color value as described hereinabove and
(b) comparing the averaged color value obtained from step (a) with a target color value range.

In this case the method according to the invention is a relative method. The meeting of a color target is thus preferably verified by evaluating the difference between for example the database values of reference samples and the averaged color value of the analyzed sample. It is preferable when the method according to the invention measures only deviations in the averaged color value. This has the advantage that absolute values of the averaged color value often depend on the employed apparatus. It is accordingly possible to define the same target color value deviation for different plants and thus standardize the method.

The target color value is particularly preferably determined by analyzing an injection-molded color plate of the transparent reference sample by recording a transmission spectrum in a wavelength range of 360-780 nm or by directly determining the color values XYZ in transmission, wherein the transparent reference sample has the desired color value.

It is moreover preferable when the method according to the invention is characterized in that in addition to steps (a) and (b) the method comprises the following step:
(c) in case of deviation of the averaged color value obtained from step (a) from the target color value range in the comparison of step (b), discarding the corresponding volume elements of the transparent sample having the deviating averaged color value.

According to the invention it is possible to reduce the amount of scrap transparent sample resulting from step (c) compared to prior art methods. In particular, the control loop is shorter according to the invention and therefore deviations from the target color value range can be identified more quickly. It is thus also possible to intervene in the production process more quickly. This results in an improvement in the homogeneity of the batch and in a narrower distribution of the sample in the target color value range. It is thus moreover preferred when the method according to the invention is characterized in that the method is used for quality control in the production of the transparent sample and and in that in addition to steps (a) and (b) and optionally (c) it comprises the following step:
(d) in case of deviation of the averaged color value obtained from step (a) from the target color value range in the comparison of step (b), intervening in the production process of the transparent sample by adapting at least one parameter of the production process.

It is preferable when adapting of the colorant concentration is carried out in step (d).

As already elucidated hereinabove it has surprisingly been found that the thermochromic effect is negligible in the method according to the invention. It is particularly preferable when the method according to the invention is carried out in a temperature range of 20° C. to 80° C., preferably 30° C. to 75° C. The transparent sample can have a temperature gradient of 120° C. to 20° C. It is moreover preferable when a temperature sensor is integrated. Said sensor is preferably integrated immediately upstream of the measurement of the method according to the invention. The measurement is here carried out in a manner known to those skilled in the art, for example through measurement in the granulate.

In a further aspect of the present invention a first embodiment provides a sample of a transparent bulk material comprising a multiplicity of transparent, discrete solid particles, characterized in that the standard deviation of the CIELab coordinate a* of an arbitrary volume element from the target value a* is −0.3 to 0.3, preferably −0.2 to 0.2 and very particularly preferably −0.1 to 0.1, wherein the CIELab coordinate a* is determined from a transmission spectrum of the arbitrary volume element of the transparent sample in a wavelength range of 360-780 nm or by direct determination of the color values XYZ in transmission and the arbitrary volume element has a CIELab coordinate L* of not more than 95, preferably not more than 90, particularly preferably not more than 85 and very particularly preferably not more than 80. It is likewise preferable when the arbitrary volume element has a CIELab coordinate L* of not less than 5, particularly preferably not less than 10, very particularly preferably not less than 20.

A second embodiment provides a sample of a transparent bulk material comprising a multiplicity of transparent, discrete solid particles, characterized in that the standard deviation of the CIELab coordinate b* of an arbitrary volume element from the target value b* is −1.1 to 1.1, preferably −0.7 to 0.7 and very particularly preferably −0.5 to 0.5, wherein the CIELab coordinate b* is determined from a transmission spectrum of the arbitrary volume element of the transparent sample in a wavelength range of 360-780 nm or by direct determination of the color values XYZ in transmission and the arbitrary volume element has a CIELab coordinate L* of not more than 95, preferably not more than 90, particularly preferably not more than 85 and very particularly preferably not more than 80. It is likewise preferable when the arbitrary volume element has a CIELab coordinate L* of not less than 5, particularly preferably not less than 10, very particularly preferably not less than 20.

A third embodiment of the present invention likewise provides a sample of a transparent bulk material comprising a multiplicity of transparent, discrete solid particles, characterized in that the standard deviation of the transmission Y of an arbitrary volume element from the target transmission value Y is −0.5 to 0.5, preferably

−0.4 to 0.4 and particularly preferably −0.3 to 0.3, wherein the transmission Y is determined from a transmission spectrum of the arbitrary volume element of the transparent sample in a wavelength range of 360-780 nm or is determined by direct determination of the color values XYZ in transmission and the arbitrary volume element has a CIELab coordinate L* of not more than 95, preferably not more than 90, particularly preferably not more than 85 and very particularly preferably not more than 80. It is likewise preferable when the arbitrary volume element has a CIELab coordinate L* of not less than 5, particularly preferably not less than 10, very particularly preferably not less than 20.

In a fourth embodiment the sample according to the first or third embodiment is preferably characterized in that the standard deviation of the CIELAb coordinate b* of an arbitrary volume element from the target value b* is −1.1 to 1.1, preferably −0.7 to 0.7 and very particularly preferably −0.5 to 0.5, wherein the CIELab coordinate b* is determined from a transmission spectrum of the arbitrary volume element of the transparent sample in a wavelength range of 360-780 nm or by direct determination of the color value XYZ in transmission.

Furthermore, in a fifth embodiment the sample according to the first, second or fourth embodiment is preferably characterized in that the standard deviation of the transmission Y of an arbitrary volume element from the transmission target value is −0.5 to 0.5, preferably −0.4 to 0.4 and particularly preferably −0.3 to 0.3, wherein the transmission Y is determined from a transmission spectrum of the arbitrary volume element of the transparent sample in a wavelength range of 360-780 nm or by direct determination of the color values XYZ in transmission.

Finally, in a sixth embodiment the sample according to the fourth or fifth embodiment is preferably characterized in that the standard deviation of the CIELAb coordinate a* of an arbitrary volume element from the target value a* is −0.3 to 0.3, preferably −0.2 to 0.2 and very particularly preferably −0.1 to 0.1, wherein the CIELab coordinate a* is determined from a transmission spectrum of the arbitrary volume element of the transparent sample in a wavelength range of 360-780 nm or by direct determination of the color value XYZ in transmission.

In a further embodiment the inventive sample according to any of the abovementioned embodiments are preferably characterized in that the standard deviation of the yellowness index YI of an arbitrary volume element from the yellowness index target value YI is −0.5 to 0.5, preferably −0.4 to 0, 4 and particularly preferably −0.3 to 0.3, wherein the yellowness index YI is determined from a transmission spectrum of the arbitrary volume element of the transparent sample in a wavelength range of 360-780 nm or is determined by direct determination of the color values XYZ in transmission. The YI is preferably determined according to ASTM E 313-10 (observer: 10°/light type: D65) on sample plates with a film thickness of 4 mm.

As described hereinabove, the method according to the invention has the result that in the production of a transparent bulk material, preferably a transparent polymer, the control loop becomes shorter. This improves the homogeneity of a sample of the transparent bulk material.

This has the result that when an arbitrary discrete solid particle is removed from the sample of the transparent bulk material and said particle is analyzed with regard to the target color value, the probability that said particle has the target color value range is higher than in the prior art methods. An arbitrary volume element of the sample according to the invention thus has a narrower distribution of the target color value range than prior art volume elements. It is preferable here when the arbitrary volume element comprises at least 1000 to 5000 discrete solid particles.

Standard deviation is preferably determined at an N of 500 to 1500, particularly preferably 750 to 1250 and very particularly preferably of 900 to 1100. It is moreover preferable when the standard deviation is calculated as “population standard deviation” according to the following formula:

$$σ = S = \sqrt{\frac{1}{N} {\sum }_{i = 1}^{N} {( {X}_{i} - μ )}^{2}}$$

where
σ=standard deviation
μ=average value of the population
X=measured value
N=number of values in the population

The samples according to the invention are preferably obtained via the method according to the invention. All preferences described for the method according to the invention especially apply. In particular it is preferable when the sample of a transparent bulk material according to the invention comprises a transparent polymer. It may preferably also consist of a transparent polymer, wherein the polymer may still contain traces of the residual substances generated during production. The transparent polymer is moreover preferably selected from the group consisting of polycarbonate, polymethacrylate, polystyrene and styrene-acrylonitrile copolymers; the transparent sample is very particularly preferably a polycarbonate.

It is moreover preferable when the sample according to the invention exclusively comprises absorbent, non-scattering colorants and/or pigments for coloring. The sample according to the invention may further comprise further non-scattering additives. These may partly also result from the production process of the sample according to the invention. It is preferable when, in addition to the abovementioned absorbent, non-scattering colorants and/or pigments for coloring, the sample according to the invention may optionally contain at least one further additive selected from the group consisting of UV absorbers, IR absorbers, flame retardants, mold release agents, stabilizers and nanoparticles. It must be ensured that the sample according to the invention remains transparent. This preferably means that it conforms to the abovementioned definition of the term “transparent”. In this context it is preferable when the term “non-scattering” means that the sample has a haze, measured on a 4 mm plate, of less than 5% according to ASTM D 1003 (2011 version).

A further aspect of the present invention provides a shaped article which comprises the sample according to the invention as described hereinabove. It is moreover preferable when the shaped article is formed by melting the sample according to the invention and cooling it until solidification. The shaped articles according to the invention are producible for example by injection molding, extrusion and blow molding processes. A further mode of production of shaped articles is thermoforming from previously produced plates or films.

The shaped article according to the invention may preferably also contain customary polymer additives such as impact modifiers, flame retardants, flame retardant synergists, antidrip agents (for example compounds from the classes of fluorinated polyolefins, silicones and aramid fibers), lubricants and mold release agents (for example pentaerythritol tetrastearate), nucleating agents, antistats, stabilizers, fillers and reinforcers (for example glass or carbon fibers, mica, kaolin, talc, CaCO₃ and glass flakes) and also dyes and pigments.

A further aspect of the present invention relates to an apparatus for determining an averaged color value of a sample of a transparent bulk material, wherein the sample comprises a plurality of transparent, discrete solid particles, comprising an apparatus for setting into motion the volume element of the sample to be analyzed, wherein the volume element of the sample to be analyzed is in motion at least immediately before and after the analysis so that the bulk density of any volume element to be analyzed may vary, and a spectrophotometer for recording a transmission spectrum of any analyzed volume element in the transparent sample in a wavelength range of 360-780 nm or an XYZ detector for continuous determination of the color values XYZ in transmission of any analyzed volume element in the transparent sample, wherein for each analyzed volume element a color value is obtained and this color value is subsequently averaged over a number of the analyzed volume elements to obtain the averaged color value, wherein the spectrophotometer is calibrated such that only data for analyzed volume elements which have a CIELab coordinate L* of not more than 95, preferably not more than 90, particularly preferably not more than 85 and very particularly preferably not more than 80 are taken into account for calculating the averaged color value. It is likewise preferable when only data for analyzed volume elements which have a CIELab coordinate L* of not less than 5, particularly preferably not less than 10, very particularly preferably not less than 20, are taken into account. According to the invention it is preferable when the spectrophotometer is calibrated using calibration standards. The term “calibration standards” is preferably to be understood as meaning samples having a defined transmission. The apparatus according to the invention is preferably used to perform the method according to the invention. All preferences described with regard to the method according to the invention also apply to the apparatus according to the invention. The apparatus according to the invention preferably comprises a flow of the transparent sample described hereinabove. It is particularly preferable when the transparent sample is in continuous motion as described hereinabove. The apparatus according to the invention moreover preferably comprises a light source arranged such that it transilluminates the flow of the transparent sample. It is preferably arranged substantially at right angles to the flow of the transparent sample. The light source is suitable for recording a transmission spectrum or the color values with the apparatus according to the invention in a manner known to those skilled in the art. It is particularly suitable for recording the color values XYZ. A receiver is preferably arranged at the point at which light arrives after the light from the light source has penetrated the flow of the transparent sample. The receiver preferably directs the received light to a color measuring apparatus. It is further preferable when the color measuring apparatus contains either an XYZ detector or a spectrophotometer. The data from the detector or spectrophotometer are preferably passed on to a processing unit. The processing unit calculates the averaged color value when for each analyzed volume element a color value is obtained and this color value is subsequently averaged over a number of the analyzed volume elements to obtain the averaged color value.

In a further aspect the invention also relates to the use of an XYZ detector for determining the color values XYZ in transmission in a continuous analysis of a transparent sample. The preferences more particularly elucidated hereinabove also apply in this use according to the invention.

### EXAMPLES

Different polymer granulates were analyzed (see figures and tables below). This was carried out using the following apparatus in all cases (reference is made to the reference symbols of FIG. 1 for example):

The flow rate of any granulate was adjusted using an aperture (7) and by utilizing gravity. 180 kg of granulate per hour was analyzed in each case. Cylindrical granulates having an average size of 4 mm in diameter and 5 mm in length were analyzed. The granulate flowed through a measuring cell having dimensions of 10×10 cm, wherein the illuminated measuring cell depth was 12 mm. The glass plates (6) shown in FIG. 1 had a size of 10×10 cm and a spacing from one another of 12 mm. The glass plates were each 2 mm thick. A white LED illuminant was used as the light source (4). A collimator lens was used as a filter element (2) to reduce the scattered light (3). A PRO128—CIELAB Color Sensor XYZ detector from Premosys (5) and a VIS spectrophotometer from Ocean Optics (9) were used as the receiver. XYZ color values were measured directly via the sensor. Altogether one volume element was analyzed every 16 ms.

### Example 1

### Bisphenol A-Based Polycarbonate Comprising Mold Release Agent and UV Absorber

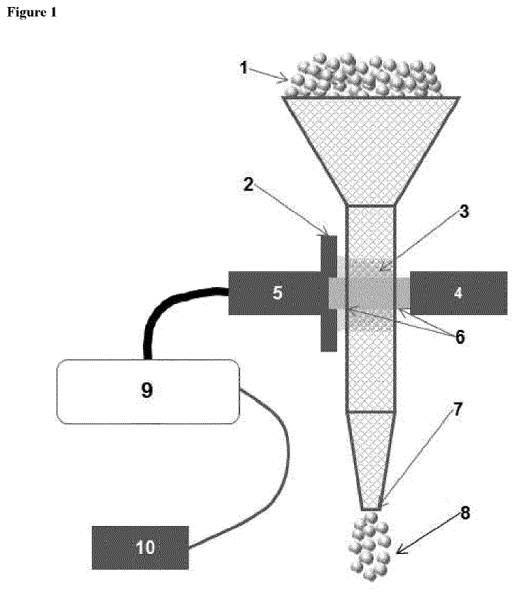

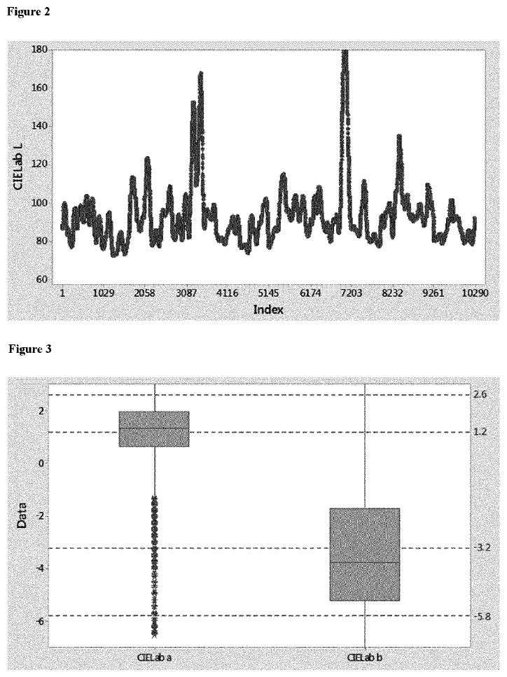

The sample was analyzed as described hereinabove. Approx. 10500 color values were obtained. FIG. 2 shows the unfiltered L* values of the sample versus the number of analyzed volume elements. A box plot of the CIELab coordinates a* and b* was formed from these values with the software MiniTab 17 (FIG. 3). The formation of a box plot is known to those skilled in the art. It provides statistical information about the range in which 50% of all the obtained data lie (within the marked box). FIG. 3 also defines target values (1.2 to 2.6 for CIELab coordinate a* and −5.8 to −3.2 for CIELab coordinate b*). These target values correspond to the CIELab coordinates of the analyzed granulate obtained using the prior art plate method. It is apparent from FIG. 3 that a large proportion of the boxes in the box plot lie outside the target values.

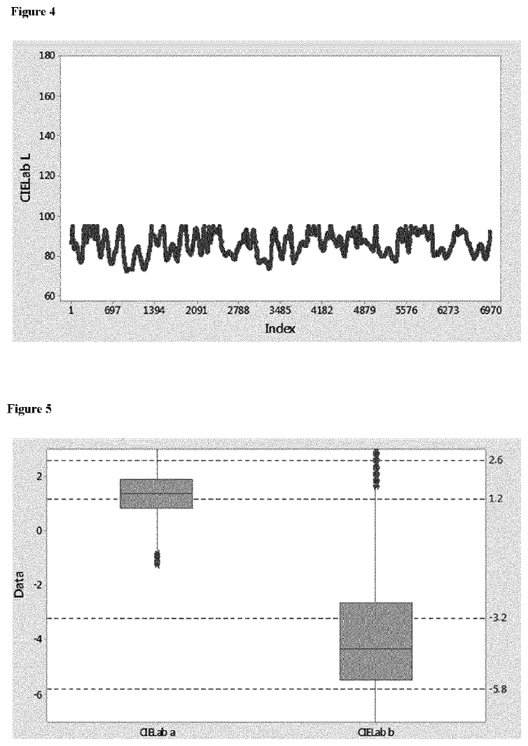

FIG. 4 shows the same data as FIG. 2 but the data have been cleaned up such that data having a CIELab coordinate L* of more than 95 have been hidden (inventive cleanup of the data). The resulting box plot is shown in FIG. 5. It is apparent here that as a result of the cleanup of the data the boxes for the CIELab coordinates a* and b* fit the target ranges much better than in FIG. 3 with the unfiltered data.

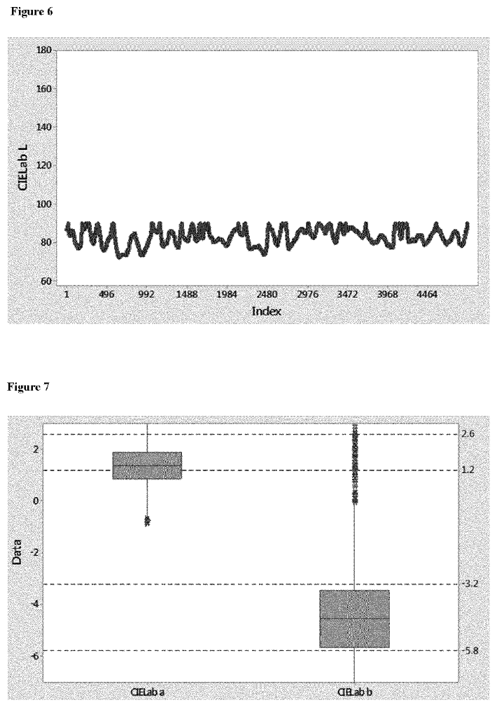

This effect can be improved a little further when the data are cleaned up again such that data having a CIELab coordinate L* of more than 90 are hidden (FIG. 6 and FIG. 7).

It is apparent from these data that the inventive cleanup of the obtained data to a maximum L* value of 95 affords reliable averaged color values compared to the color values obtained from the standard method.

### Example 2

### Randomization of the Data for a Bisphenol A-Based Polycarbonate

The sample was analyzed as described hereinabove. About 18 000 data points were obtained. These data were randomized using the software MiniTab version 17. As is apparent from table 1, reduction to 9000 data points, to 4500 data points, to 2000 data points and to 1000 data points still results in substantially identical process capability. This means that the same information about the color value can still be obtained when markedly fewer data points are to be processed.

TABLE 1
Randomization of data

| Number of data points | Process capability (Ppk) |
|---|---|
| 18359 | 0.61 |
| 9000 | 0.61 |
| 4500 | 0.60 |
| 2000 | 0.61 |
| 1000 | 0.62 |

### Further Examples

The values shown in the following tables each correspond to the averaged color value of a sample batch. The values shown are in each case an average value over about 5000 volume elements. The color values having a CIELab coordinate L* of more than 95 were not included in the calculation of the averaged color value.

Temperature was measured using a temperature sensor directly in the granulate flow immediately upstream of the measuring cell.

By way of comparison a 4 mm thick plate was in each case injection molded from an analyzed volume element (“plate” values in the tables). These were analyzed at room temperature. In all cases the delta-a*, delta-b* and Y values were calculated according to CIELab according to DIN EN ISO 11664-4 (2011). The yellowness index (YI) based on the color values XYZ was calculated according to ASTM E 313-10 (observer: 10°/light type: D65).

### Example 3

### Bisphenol A-Based Polycarbonate

| 4 mm Plate | | | | |
|---|---|---|---|---|
| (comparison) | | Inventive | | |
| Y (%) | YI | Y (%) | YI | Temperature (° C.) |
| 89.6 | 2.3 | 89.4 | 2.2 | 27 |
| 89.5 | 2.4 | 89.8 | 2 | 29 |
| 89.6 | 2.1 | 89.6 | 2.2 | 29 |
| 89.5 | 2.1 | 89.4 | 1.9 | 32 |
| 89.5 | 2.1 | 89.4 | 2.4 | 30 |
| 89.5 | 2.1 | 88.7 | 1.7 | 29 |

### Example 4

### Bisphenol A-Based Polycarbonate Comprising Heat Stabilizer

| 4 mm Plate | | | | |
|---|---|---|---|---|
| (comparison) | | Inventive | | |
| Y (%) | YI | Y (%) | YI | Temperature (° C.) |
| 89.6 | 1.7 | 89.7 | 1.7 | 33 |
| 89.7 | 1.7 | 89.4 | 1.7 | 33 |
| 89.7 | 1.6 | 90.1 | 1.4 | 30 |
| 89.7 | 1.7 | 89.3 | 1.8 | 29 |
| 88.4 | 2 | 88.4 | 2.1 | 27 |
| 88.8 | 2.8 | 88.7 | 2.6 | 33 |
| 88.9 | 2.6 | 89 | 2.4 | 33 |

### Example 5

### Bisphenol A-based Polycarbonate Comprising 0.4% By Weight of Branching Agent and Heat Stabilizer

| 4 mm Plate | | | | |
|---|---|---|---|---|
| (comparison) | | Inventive | | |
| Y (%) | YI | Y (%) | YI | Temperature (° C.) |
| 89.7 | 2.4 | 89.7 | 2.6 | 34 |
| 89.6 | 2.5 | 89.9 | 2.3 | 34 |
| 89.4 | 2.4 | 89.5 | 2.6 | 32 |
| 89.5 | 2.3 | 89.5 | 1.8 | 28 |
| 89.5 | 2.7 | 89.0 | 2.3 | 28 |

5

### Example 6

### Polycarbonate Based On Bisphenol A and Bisphenol TMC Comprising Mould Release Agent and Heat Stabilizer

| 4 mm Plate | | | | |
|---|---|---|---|---|
| (comparison) | | Inventive | | |
| Y (%) | YI | Y (%) | YI | Temperature (° C.) |
| 90.1 | 1.3 | 90 | 1.4 | 37 |
| 89.8 | 1.5 | 90.2 | 1.5 | 39 |
| 90.2 | 1.4 | 89.9 | 1.4 | 39 |
| 89.7 | 1.7 | 89.5 | 1.3 | 32 |
| 90 | 1.3 | 89.6 | 1.3 | 34 |
| 90 | 1.5 | 89.6 | 1 | 37 |
| 89.9 | 1.3 | 89.9 | 1.2 | 39 |
| 90.1 | 1.3 | 89.9 | 1.4 | 37 |
| 89.8 | 1.5 | 89.6 | 1.2 | 27 |
| 89.9 | 1.4 | 89.5 | 1.3 | 33 |
| 89.9 | 1.4 | 89.5 | 1.4 | 29 |
| 89.9 | 1.5 | 90 | 1.2 | 34 |
| 89.9 | 1.6 | 90 | 1.7 | 31 |
| 90.1 | 1.4 | 89.8 | 1.4 | 40 |
| 89.9 | 1.7 | 89.6 | 1.6 | 34 |

As shown by the results, the averaged color values obtained according to the invention are comparable to those obtained using the prior art colored plate method. These results apply for all of the different polymer samples used. It is especially surprising that the temperature of the granulate has hardly any influence on the obtained averaged color values.

1. A method for determining an averaged color value of a sample of a transparent bulk material, wherein the sample comprises a multiplicity of transparent, discrete solid particles, wherein the determination is carried out continuously over different volume elements of the sample, wherein the volume element of the sample to be analyzed is in motion at least immediately before and after the analysis so that the a bulk density of any volume element to be analyzed may vary, wherein for each analyzed volume element a color value is obtained and this color value is subsequently averaged over a number of the analyzed volume elements to obtain an averaged color value, wherein the color value of any volume element to be analyzed is obtained in transmission by recording a transmission spectrum in a wavelength range of 360-780 nm or by direct determination of color values XYZ and only color values of an analyzed volume element for which a CIELab coordinate L* of not more than 95 was obtained from the measured data are taken into account for calculating the averaged color value.

2. The method as claimed in claim 1, wherein a volume element is analyzed at least every 20 ms and at most every 1 s.

3. The method as claimed in claim 1, wherein 2000 to 7000 volume elements are analyzed and the averaged color value is obtained by averaging this number of analyzed volume elements with the proviso that these analyzed volume elements have a CIELab coordinate L* of not more than 95.

4. The method as claimed in claim 1, wherein the method is used for quality control of the transparent sample.

5. The method as claimed in claim 4, wherein the quality control is carried out during production of the transparent sample.

6. The method as claimed in claim 1, wherein the method comprises:
(a) determining the averaged color value as described in claim 1, and
(b) comparing the averaged color value obtained from step (a) with a target color value range.

7. The method as claimed in claim 6, wherein the method additionally comprises:
(c) in the case of deviation of the averaged color value obtained from step (a) from the target color value range in the comparison of step (b), discarding the corresponding volume elements of the transparent sample having the deviating averaged color value.

8. The method as claimed in claim 6, wherein the method is used for quality control in a production process of the transparent sample and wherein the method additionally comprises:
(d) in the case of deviation of the averaged color value obtained from step (a) from the target color value range in the comparison of step (b), intervening in the production process of the transparent sample by adapting at least one parameter of the production process.

9. The sample of the transparent bulk material of claim 18, wherein the standard deviation of the CIELab coordinate a* of an arbitrary volume element from the target color value a* is −0.3 to 0.3.

10. The sample of the transparent bulk material of claim 18 wherein the standard deviation of the CIELab coordinate b* of the arbitrary volume element from the target color value b* is −1.1 to 1.1.

11. The sample of a transparent bulk material of claim 18 wherein the standard deviation of the transmission Y of the arbitrary volume element from the target transmission value Y is −0.5 to 0.5.

12. The sample as claimed in claim 9, wherein a standard deviation of a yellowness index YI of an arbitrary volume element from the a yellowness index target value YI is −0.5 to 0.5, wherein the yellowness index YI is determined from a transmission spectrum of the arbitrary volume element of transparent sample in a wavelength range of 360-780 nm or by direct determination of the color values XYZ in transmission and the arbitrary volume element has a CIELab coordinate L* of not more than 95.

13. A shaped article comprising the sample according to claim 18.

14. A system for determining the averaged color value of the sample of the transparent bulk material as claimed in claim 1, the system comprising an apparatus for setting into motion the volume element of the sample to be analyzed, and a spectrophotometer for recording the transmission spectrum of any analyzed volume element in the transparent sample in the wavelength range of 360-780 nm or an XYZ detector for continuous determination of the color values XYZ in transmission of any analyzed volume element in the transparent sample, wherein the spectrophotometer is calibrated such that only data for analyzed volume elements which have a CIELab coordinate L* of not more than 95 are taken into account for calculating the averaged color value.

15. A method comprising determining a color value XYZ in transmission using an XYZ detector in a continuous analysis of a transparent sample.

16. The sample as claimed in claim 10, wherein a standard deviation of a yellowness index YI of an arbitrary volume element from a yellowness index target value YI is −0.5 to 0.5, wherein the yellowness index YI is determined from a transmission spectrum of the arbitrary volume element of the transparent sample in a wavelength range of 360-780 nm or by direct determination of color values XYZ in transmission and the arbitrary volume element has a CIELab coordinate L* of not more than 95.

17. The sample as claimed in claim 11, wherein a standard deviation of a yellowness index YI of an arbitrary volume element from a yellowness index target value YI is −0.5 to 0.5, wherein the yellowness index YI is determined from a transmission spectrum of the arbitrary volume element of the transparent sample in a wavelength range of 360-780 nm or by direct determination of color values XYZ in transmission and the arbitrary volume element has a CIELab coordinate L* of not more than 95.

18. A sample of a transparent bulk material comprising a multiplicity of transparent, discrete solid particles, wherein at least one of a standard deviation of a CIELab coordinate a* of an arbitrary volume element from a target color value a* is −0.3 to 0.3, wherein the CIELab coordinate a* is determined from a transmission spectrum of the arbitrary volume element of the transparent sample in a wavelength range of 360-780 nm or by direct determination of color values XYZ in transmission and the arbitrary volume element has a CIELab coordinate L* of not more than 95;
a standard deviation of a CIELab coordinate b* of an arbitrary volume element from a target color value b* is −1.1 to 1.1, wherein the CIELab coordinate b* is determined from a transmission spectrum of the arbitrary volume element of the transparent sample in a wavelength range of 360-780 nm or by direct determination of the color values XYZ in transmission and the arbitrary volume element has a CIELab coordinate L* of not more than 95; and
a standard deviation of a transmission Y of an arbitrary volume element from a target transmission value Y is −0.5 to 0.5, wherein the transmission Y is determined from a transmission spectrum of the arbitrary volume element of the transparent sample in a wavelength range of 360-780 nm or by direct determination of color values XYZ in transmission and the arbitrary volume element has a CIELab coordinate L* of not more than 95.
